(19) United States
(12) Patent Application Publication
(10) Pub. No.: US 2026/0038445 A1
(43) Pub. Date: Feb. 5, 2026

(54) DISPLAY DEVICE AND ELECTRONIC DEVICE INCLUDING THE SAME

(71) Applicant: Samsung Display Co., LTD., Yongin-si (KR)

(72) Inventors: Jungeon An, Yongin-si (KR); KIHYUN PYUN, Yongin-si (KR)

(21) Appl. No.: 19/220,616

(22) Filed: May 28, 2025

(30) Foreign Application Priority Data
Jul. 30, 2024 (KR) 10-2024-0100802

(51) Int. Cl. G09G 3/3266; G09G 3/3275

(52) U.S. Cl. CPC G09G 3/3266; G09G 3/3275; G09G 2320/0626; G09G 2330/021; G09G 2330/028

(57) ABSTRACT

A display device may include a display panel, a gate driving circuit, a data driving circuit, a driving voltage supplying circuit, and a driving control circuit that controls the gate driving circuit, the data driving circuit, and the driving voltage supplying circuit. The driving voltage supplying circuit supplies a gate driving voltage, a data driving voltage, and a panel driving voltage including a first power supply voltage and a second power supply voltage lower than the first power supply voltage. The driving control circuit determines a scale factor based on a load of input frame data, generates output frame data by applying the scale factor to the input frame data, and determines the first power supply voltage and an input power supply voltage for generating the first power supply voltage based on a maximum grayscale of the input frame data and a load of the output frame data.

This application claims priority to Korean Patent Application No. 10-2024-0100802, filed on Jul. 30, 2024, and all the benefits accruing therefrom under 35 U.S.C. § 119, the content of which in its entirety is herein incorporated by reference.

### BACKGROUND

### 1. Field

Embodiments of the present disclosure relate to a display device. More particularly, embodiments of the present disclosure relate to a display device having a net power control function and a variable power supply voltage function and an electronic device including the display device.

### 2. Description of the Related Art

In general, a display device may include a display panel that displays an image corresponding to input frame data and a display panel driver that drives the display panel. The display panel may include gate lines, data lines, and pixels connected to the gate lines and the data lines. The display panel driver may include a gate driving circuit that provides a gate signal to the pixels via the gate lines, a data driving circuit that provides a data signal (i.e., data voltages) to the pixels via the data lines, and a driving control circuit that controls the gate driving circuit and the data driving circuit.

### SUMMARY

Display devices may employ a net power control (NPC) function, which adjusts luminance (or brightness) of the display panel by applying a scale factor to the input frame data based on the load of the input frame data, and a smart power control (SPC) function (e.g., also referred to as a variable power supply voltage function), which varies a power supply voltage (e.g., ELVDD, etc.) based on the load and/or the maximum grayscale of the input frame data. There is a growing demand for improving power consumption as the display device performs the net power control function and the smart power control function.

An embodiment of the present disclosure is to provide a display device capable of efficiently reducing unnecessary power consumption in a driving voltage supply circuit while performing a net power control function and a variable power supply voltage function.

Another embodiment of the present disclosure is to provide an electronic device including the display device.

However, embodiments of the present disclosure are not limited to the above embodiments, and may be variously extended without departing from the spirit and scope of the present disclosure.

According to embodiments, a display device includes a display panel including pixels, a gate driving circuit which provides a gate signal to the display panel, a data driving circuit which provides a data signal to the display panel, a driving voltage supplying circuit which supplies a gate driving voltage to the gate driving circuit, supplies a data driving voltage to the data driving circuit, and supplies a panel driving voltage including a first power supply voltage and a second power supply voltage lower than the first power supply voltage to the display panel, and a driving control circuit which controls the gate driving circuit, the data driving circuit, and the driving voltage supplying circuit. In such embodiments, the driving control circuit determines a scale factor based on a load of input frame data, may generate output frame data by applying the scale factor to the input frame data, and determines the first power supply voltage and an input power supply voltage for generating the first power supply voltage based on a maximum grayscale of the input frame data and a load of the output frame data.

In embodiments, the driving control circuit may determine the input power supply voltage to be higher than the first power supply voltage by a predetermined voltage, and the driving voltage supplying circuit may generate the first power supply voltage by buck-converting the input power supply voltage.

In embodiments, the scale factor may be determined based on a net power control graph indicating a correlation between the scale factor and the load of the input frame data.

In embodiments, the scale factor may decrease as the load of the input frame data increases when the load of the input frame data is greater than a reference load in the net power control graph.

In embodiments, the first power supply voltage may be determined based on a power supply voltage variation graph indicating a correlation among the first power supply voltage, the load of the output frame data, and the maximum grayscale of the input frame data.

In embodiments, the first power supply voltage may increase as the maximum grayscale of the input frame data increases and may increase as the load of the output frame data increases in the power supply voltage variation graph.

According to embodiments, a display device includes a display panel including pixels, a gate driving circuit which provides a gate signal to the display panel, a data driving circuit which provides a data signal to the display panel, a driving voltage supplying circuit which supplies a gate driving voltage to the gate driving circuit, supplies a data driving voltage to the data driving circuit, and supplies a panel driving voltage including a first power supply voltage and a second power supply voltage lower than the first power supply voltage to the display panel, and a driving control circuit which controls the gate driving circuit, the data driving circuit, and the driving voltage supplying circuit. In such embodiments, the driving control circuit determines a scale factor based on a load of input frame data, generates output frame data by applying the scale factor to the input frame data, and determines the first power supply voltage and an input power supply voltage for generating the first power supply voltage based on a brightness mode of the display panel.

In embodiments, the driving control circuit may determine the input power supply voltage to be higher than the first power supply voltage by a predetermined voltage, and the driving voltage supplying circuit may generate the first power supply voltage by buck-converting the input power supply voltage.

In embodiments, the driving control circuit may determine a first set voltage as the first power supply voltage when the brightness mode is a high-brightness mode having a first dynamic range and may determine a second set voltage lower than the first set voltage as the first power supply voltage when the brightness mode is a low-brightness mode having a second dynamic range narrower than the first dynamic range.

In embodiments, the scale factor may be determined based on a first net power control graph indicating a first correlation between the scale factor and the load of the input frame data when the brightness mode is the high-brightness mode. In such embodiments, the scale factor may be determined based on a second net power control graph indicating a second correlation between the scale factor and the load of the input frame data when the brightness mode is the low-brightness mode.

In embodiments, the scale factor may decrease as the load of the input frame data increases when the load of the input frame data is greater than a reference load in the first net power control graph. In such embodiments, the scale factor may have a predetermined fixed value regardless of the load of the input frame data in the second net power control graph.

In embodiments, the first power supply voltage may be determined based on a power supply voltage variation graph indicating a correlation among the first power supply voltage, the load of the output frame data, and a luminance usage range of the brightness mode.

In embodiments, when the brightness mode is the high-brightness mode, the first set voltage corresponding to a maximum usage luminance of the high-brightness mode may be determined as the first power supply voltage in the power supply voltage variation graph.

In embodiments, when the brightness mode is the low-brightness mode, the second set voltage corresponding to a maximum usage luminance of the low-brightness mode may be determined as the first power supply voltage in the power supply voltage variation graph.

According to embodiments, an electronic device may include a processor which renders input frame data and a display device which displays an image corresponding to output frame data generated by applying a scale factor to the input frame data on a display panel and varies a first power supply voltage applied to the display panel and an input power supply voltage for generating the first power supply voltage based on a maximum grayscale of the input frame data and a load of the output frame data.

In embodiments, the display device may include the display panel including pixels, a gate driving circuit which provides a gate signal to the display panel, a data driving circuit which provides a data signal to the display panel, a driving voltage supplying circuit which supplies a gate driving voltage to the gate driving circuit, a data driving voltage to the data driving circuit, and a panel driving voltage including the first power supply voltage and a second power supply voltage lower than the first power supply voltage to the display panel, and a driving control circuit which controls the gate driving circuit, the data driving circuit, and the driving voltage supplying circuit. In such embodiments, the driving control circuit may determine the scale factor based on a load of the input frame data, may generate the output frame data by applying the scale factor to the input frame data, and may determine the first power supply voltage and the input power supply voltage based on the maximum grayscale of the input frame data and the load of the output frame data.

In embodiments, the driving control circuit may determine the input power supply voltage to be higher than the first power supply voltage by a predetermined voltage. In such embodiments, the driving voltage supplying circuit may generate the first power supply voltage by buck-converting the input power supply voltage.

According to embodiments, an electronic device may include a processor which renders input frame data and a display device which displays an image corresponding to output frame data generated by applying a scale factor to the input frame data on a display panel and varies a first power supply voltage applied to the display panel and an input power supply voltage for generating the first power supply voltage based on a brightness mode of the display panel.

In embodiments, the display device may include the display panel including pixels, a gate driving circuit which provides a gate signal to the display panel, a data driving circuit which provides a data signal to the display panel, a driving voltage supplying circuit which supplies a gate driving voltage to the gate driving circuit, supplies a data driving voltage to the data driving circuit, and supplies a panel driving voltage including the first power supply voltage and a second power supply voltage lower than the first power supply voltage to the display panel, and a driving control circuit which controls the gate driving circuit, the data driving circuit, and the driving voltage supplying circuit. In such embodiments, the driving control circuit may determine the scale factor based on a load of the input frame data, may generate the output frame data by applying the scale factor to the input frame data, and may determine the first power supply voltage and the input power supply voltage based on the brightness mode of the display panel.

In embodiments, the driving control circuit may determine the input power supply voltage to be higher than the first power supply voltage by a predetermined voltage. In such embodiments, the driving voltage supplying circuit may generate the first power supply voltage by buck-converting the input power supply voltage.

Therefore, a display device according to embodiments may include a display panel including pixels, a gate driving circuit which provides a gate signal to the display panel, a data driving circuit which provides a data signal to the display panel, a driving voltage supplying circuit which supplies a gate driving voltage to the gate driving circuit, supplies a data driving voltage to the data driving circuit, and supplies a panel driving voltage including a first power supply voltage and a second power supply voltage lower than the first power supply voltage to the display panel, and a driving control circuit which controls the gate driving circuit, the data driving circuit, and the driving voltage supplying circuit. In such embodiments, by controlling the driving control circuit to determine a scale factor based on a load of input frame data, to generate output frame data by applying the scale factor to the input frame data, and to determine the first power supply voltage and an input power supply voltage for generating the first power supply voltage based on a maximum grayscale of the input frame data and a load of the output frame data or based on a brightness mode of the display panel, the display device may optimize a buck-converting efficiency according to the input power supply voltage with respect to a first power supply voltage generating block included in the driving voltage supplying circuit to efficiently reduce unnecessary power consumption of the driving voltage supplying circuit when performing a net power control function and a variable power supply voltage function.

In such embodiments, an electronic device according to embodiments may exhibit an improved power consumption performance by including the display device.

However, effects of the present disclosure are not limited to the above effects, and may be variously extended without departing from the spirit and scope of the present disclosure.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments.

FIG. 2 is a diagram illustrating an example of a pixel included in the display device of FIG. 1.

FIG. 3 is a block diagram for describing a net power control function and a variable power supply voltage function performed by the display device of FIG. 1.

FIGS. 4A and 4B are diagrams illustrating an example in which the display device of FIG. 1 performs a net power control function.

FIGS. 5A and 5B are diagrams illustrating an example in which the display device of FIG. 1 performs a variable power supply voltage function.

FIG. 6 is a circuit diagram illustrating an example of a first power supply voltage generating block included in the display device of FIG. 1.

FIGS. 7A and 7B are diagrams for describing an operation of the first power supply voltage generating block of FIG. 6.

FIGS. 8A and 8B are graphs for describing a buck-converting efficiency according to an input power supply voltage with respect to the first power supply voltage generating block of FIG. 6.

FIG. 9 is a block diagram illustrating a display device according to embodiments.

FIG. 10 is a block diagram for describing a net power control function and a variable power supply voltage function performed by the display device of FIG. 9.

FIGS. 11A and 11B are diagrams illustrating an example in which the display device of FIG. 9 performs a net power control function.

FIGS. 12A and 12B are diagrams illustrating an example in which the display device of FIG. 9 performs a variable power supply voltage function.

FIG. 13 is a block diagram illustrating an electronic device according to embodiments.

FIG. 14 is a diagram illustrating an example in which the electronic device of FIG. 13 is implemented as a smartphone.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the present disclosure will be described in detail with reference to the accompanying drawings.

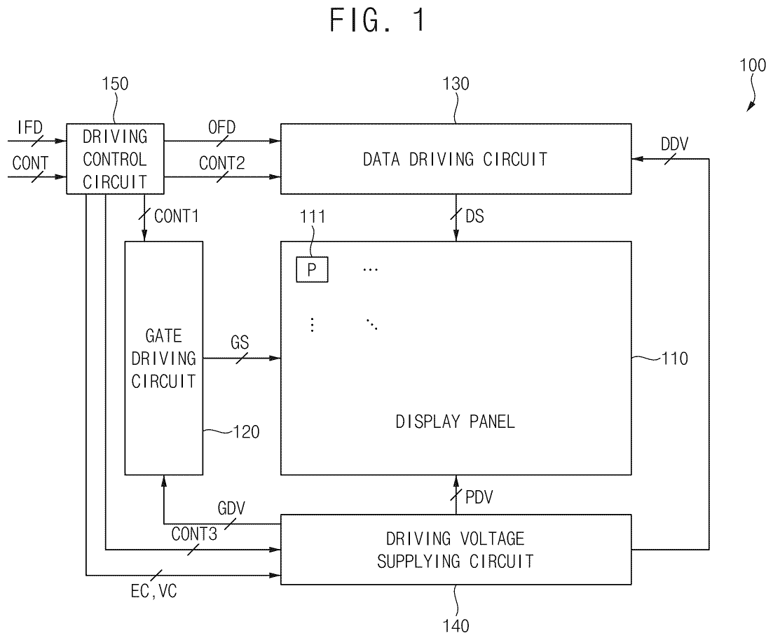

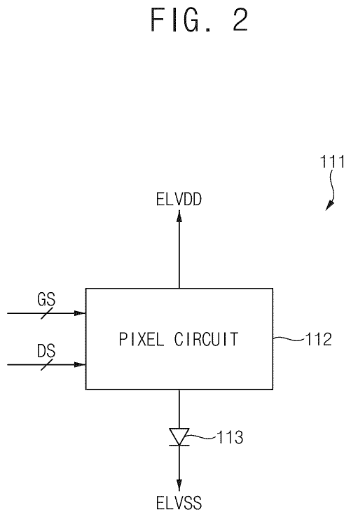

FIG. 1 is a block diagram illustrating a display device according to embodiments, and FIG. 2 is a diagram illustrating an example of a pixel included in the display device of FIG. 1.

Referring to FIGS. 1 and 2, an embodiment of the display device 100 may include a display panel 110, a gate driving circuit 120, a data driving circuit 130, a driving voltage supplying circuit 140, and a driving control circuit 150. Here, the gate driving circuit 120, the data driving circuit 130, the driving voltage supplying circuit 140, and the driving control circuit 150 may be collectively referred to as a display panel driver, and at least two or more of the gate driving circuit 120, the data driving circuit 130, the driving voltage supplying circuit 140, and the driving control circuit 150 may be integrated into a single chip or package.

The display panel 110 may include gate lines, data lines, and pixels 111 electrically connected to the gate lines and the data lines. The gate lines may extend in a first direction, and the data lines may extend in a second direction intersecting the first direction.

In an embodiment, as shown in FIG. 2, each pixel 111 may include a pixel circuit 112 and a light emitting element 113, which are connected between a first power supply voltage ELVDD and a second power supply voltage ELVSS lower than the first power supply voltage ELVDD.

The pixel circuit 112 may receive a gate signal GS from the gate driving circuit 120 and a data signal DS from the data driving circuit 130 and may allow a driving current corresponding to the data signal DS to flow through the light emitting element 113.

For this operation, the pixel circuit 112 may include a storage capacitor that stores the data signal DS, a switching transistor that transfers the data signal DS to the storage capacitor in response to a turn-on voltage of the gate signal GS, a driving transistor that allows the driving current corresponding to the data signal DS to flow through the light emitting element 113, a threshold voltage compensation transistor that compensates for a threshold voltage of the driving transistor, an initialization transistor that initializes (or resets) a specific node (e.g., a gate terminal of the driving transistor, an anode of the light emitting element 113, etc) within the pixel circuit 112, and the like. However, the pixel circuit 112 is not limited thereto.

The light emitting element 113 may emit light based on the driving current supplied from the pixel circuit 112. In an embodiment, the light emitting element 113 may be, for example, an organic light emitting diode (OLED), but it is not limited thereto.

The gate driving circuit 120 may provide the gate signal GS to the display panel 110. That is, the gate driving circuit 120 may generate the gate signal GS based on a first control signal CONT1 provided from the driving control circuit 150 and a gate driving voltage GDV supplied from the driving voltage supplying circuit 140 and may provide the gate signal GS to the pixels 111 included in the display panel 110 via the gate lines.

The first control signal CONT1 may include a vertical start signal, a gate clock signal, or the like. The gate driving voltage GDV may include a gate-on voltage and a gate-off voltage. Accordingly, the gate driving circuit 120 may generate the gate signal GS swinging between a gate-on voltage and a gate-off voltage based on the first control signal CONT1 and the gate driving voltage GDV.

The data driving circuit 130 may provide the data signals DS (i.e., data voltages) to the display panel 110. That is, the data driving circuit 130 may generate the data signal DS based on a second control signal CONT2 provided from the driving control circuit 150, output frame data OFD provided from the driving control circuit 150, and a data driving voltage DDV supplied from the driving voltage supplying circuit 140 (i.e., may perform a digital-analog conversion to convert the output frame data OFD in a digital form into the data signal DS in an analog form) and then may provide the data signal DS to the pixels 111 included in the display panel 110 through the data lines.

The second control signal CONT2 may include a horizontal start signal, a data clock signal, or the like. The data driving voltage DDV may include an analog driving voltage, a digital driving voltage, or the like. Accordingly, the data driving circuit 130 may generate the data signal DS corresponding to the output frame data OFD based on the second control signal CONT2 and the data driving voltage DDV.

The driving voltage supplying circuit 140 may supply the gate driving voltage GDV to the gate driving circuit 120, supply the data driving voltage DDV to the data driving circuit 130, and supply a panel driving voltage PDV including the first power supply voltage ELVDD and the second power supply voltage ELVSS to the display panel 110. In some embodiments, the panel driving voltage PDV may further include an initialization (or reset) voltage applied to the pixels 111 included in the display panel 110 and the like.

The driving voltage supplying circuit 140 may generate an input power supply voltage and the first power supply voltage ELVDD based on a third control signal CONT3, a first power supply voltage code EC, and an input power supply voltage code VC provided from the driving control circuit 150. In some embodiments, the third control signal CONT3 may include the first power supply voltage code EC and the input power supply voltage code VC.

In an embodiment, the driving voltage supplying circuit 140 may generate the input power supply voltage for generating the first power supply voltage ELVDD using an external power supply voltage (e.g., an alternating current (AC) voltage, a battery voltage, etc) and then may generate the first power supply voltage ELVDD using the generated input power supply voltage. Detailed description thereof will be provided below.

The driving control circuit 150 may control the gate driving circuit 120, the data driving circuit 130, and the driving voltage supplying circuit 140. In an embodiment, the driving control circuit 150 may provide the first control signal CONT1 to the gate driving circuit 120, the second control signal CONT2 to the data driving circuit 130, and the third control signal CONT3 to the driving voltage supplying circuit 140 to control the gate driving circuit 120, the data driving circuit 130, and the driving voltage supplying circuit 140.

The driving control circuit 150 may receive input frame data IFD and an input control signal CONT from a host processor (e.g., a graphic processing unit (GPU), etc). The input control signal CONT may include a master clock signal and a data enable signal. In some embodiments, the input control signal CONT may further include a vertical sync signal and a horizontal sync signal.

In an embodiment, for example, the input frame data IFD may include red image data, green image data, and blue image data. In some embodiments, the input frame data IFD may further include white image data.

In another embodiment, for example, the input frame data IFD may include magenta image data, yellow image data, and cyan image data.

The driving control circuit 150 may receive the input frame data IFD and the input control signal CONT and may generate the first control signal CONT1, the second control signal CONT2, the third control signal CONT3, and the output frame data OFD based on the input frame data IFD and the input control signal CONT.

In an embodiment, the driving control circuit 150 may generate the first control signal CONT1 for controlling an operation of the gate driving circuit 120 and then may output the first control signal CONT1 to the gate driving circuit 120. In addition, the driving control circuit 150 may generate the second control signal CONT2 for controlling an operation of the data driving circuit 130 and then may output the second control signal CONT2 to the data driving circuit 130. Further, the driving control circuit 150 may generate the third control signal CONT3 for controlling an operation of the driving voltage supplying circuit 140 and then may output the third control signal CONT3 to the driving voltage supplying circuit 140.

The driving control circuit 150 may generate the output frame data OFD based on the input frame data IFD and may output the output frame data OFD to the data driving circuit 130. The output frame data OFD may be generated by applying a scale factor to the input frame data IFD (e.g., multiplying the input frame data IFD by the scale factor having a value between 0 and 1). In some embodiments, the output frame data OFD may be generated by additionally performing a specific processing (e.g., degradation compensation, etc) on the input frame data IFD.

In embodiments, the driving control circuit 150 may perform a net power control function and a variable power supply voltage function. In an embodiment, to perform the net power control function and the variable power supply voltage function, the driving control circuit 150 may determine the scale factor based on a load of the input frame data IFD, may generate the output frame data OFD by applying the scale factor to the input frame data IFD, and may determine the first power supply voltage ELVDD and the input power supply voltage for generating the first power supply voltage ELVDD based on a maximum grayscale of the input frame data IFD and the load of the output frame data OFD. Detailed description thereof will be provided below.

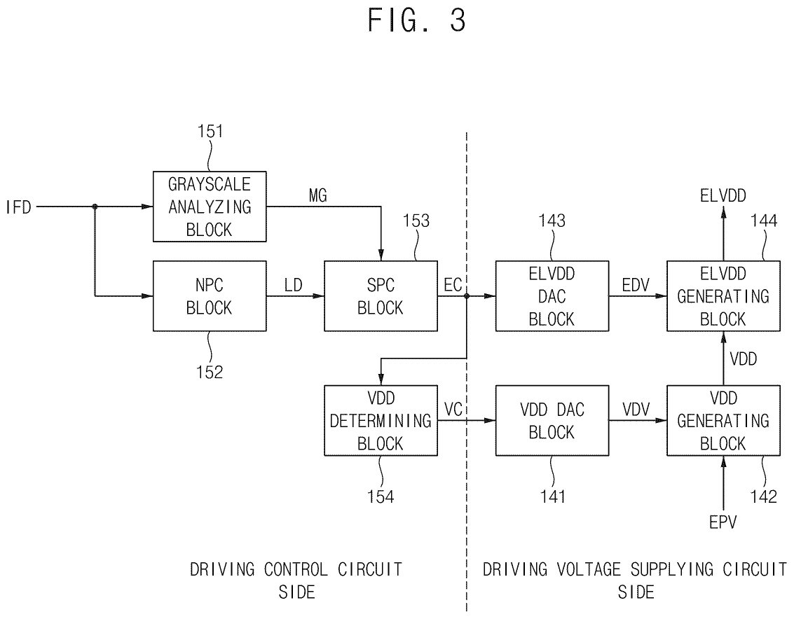

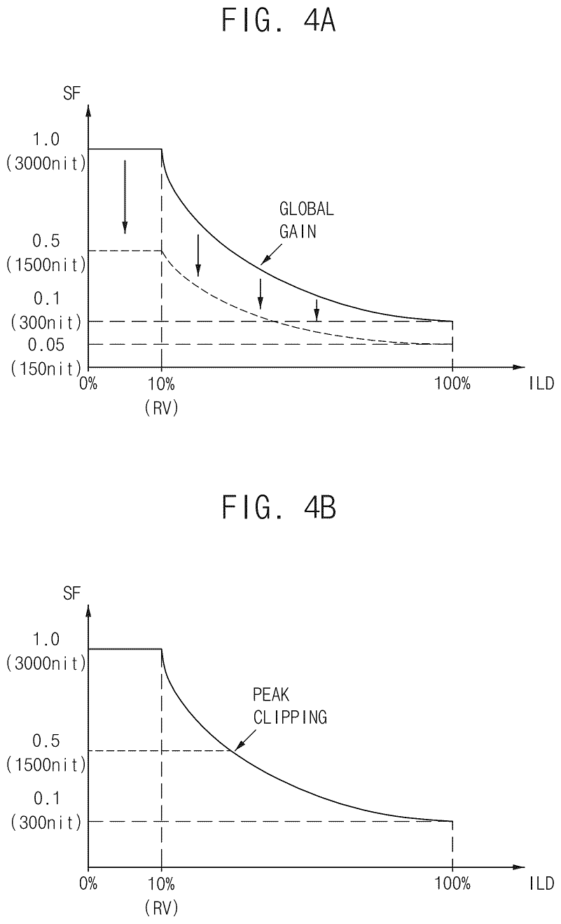

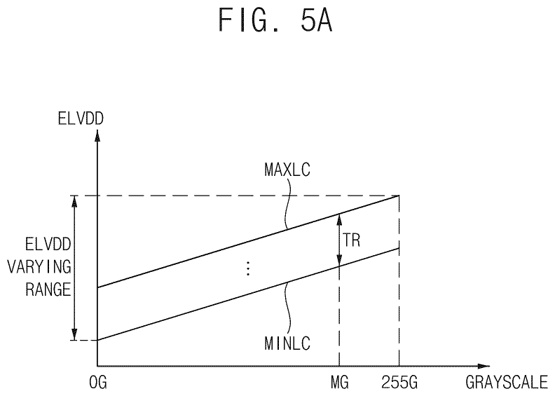

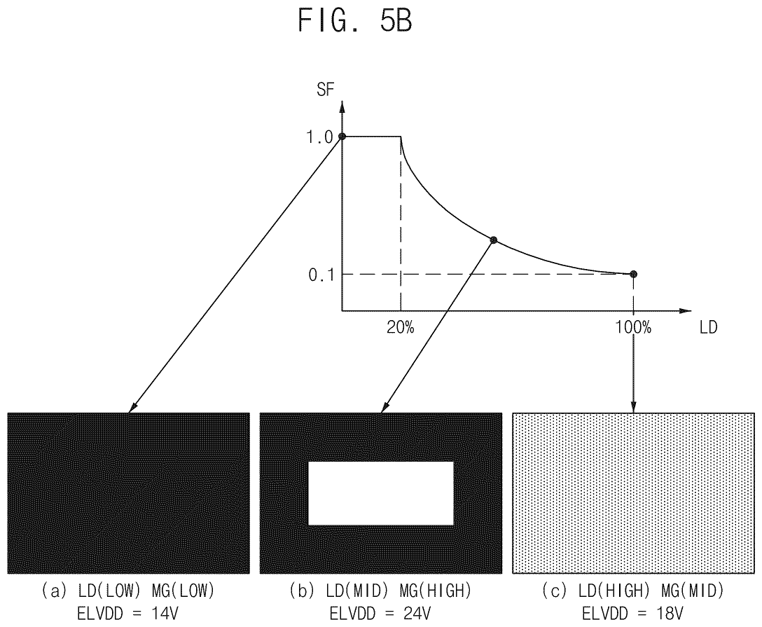

FIG. 3 is a block diagram for describing a net power control function and a variable power supply voltage function performed by the display device of FIG. 1, FIGS. 4A and 4B are diagrams illustrating an example in which the display device of FIG. 1 performs a net power control function, and FIGS. 5A and 5B are diagrams illustrating an example in which the display device of FIG. 1 performs a variable power supply voltage function.

Referring to FIGS. 3 through 5B, FIG. 3 illustrates components for performing the net power control function and the variable power supply voltage function. These components may include a grayscale analyzing block 151, a net power control block 152, a power supply voltage varying block 153, an input power supply voltage determining block 154, an input power supply voltage digital-analog converting (DAC) block 141, an input power supply voltage generating block 142, a first power supply voltage DAC block 143, and a first power supply voltage generating block 144.

As shown in FIG. 3, the grayscale analyzing block 151, the net power control block 152, the power supply voltage varying block 153, and the input power supply voltage determining block 154 may be included in (or defined by blocks of) the driving control circuit 150 while the input power supply voltage DAC block 141, the input power supply voltage generating block 142, the first power supply voltage DAC block 143, and the first power supply voltage generating block 144 may be included in (or defined by blocks of) the driving voltage supplying circuit 140.

The grayscale analyzing block 151 may receive the input frame data IFD and may analyze the input frame data IFD to determine the maximum grayscale MG of the input frame data IFD. The grayscale analyzing block 151 may provide the maximum grayscale MG of the input frame data IFD to the power supply voltage varying block 153.

The net power control block 152 may receive the input frame data IFD and may analyze the input frame data IFD to determine the load (ILD in FIGS. 4A and 4B) of the input frame data IFD (e.g., based on value obtained by summing all grayscales of the input frame data IFD, etc).

The load ILD of the input frame data IFD may be in a range from 0% to 100%. For example, when the input frame data IFD displays a full black image, the load ILD of the input frame data IFD may be 0%, and when the input frame data IFD displays a full white image, the load ILD of the input image data IFD may be 100%.

The net power control block 152 may determine the scale factor SF based on the load ILD of the input frame data IFD. The scale factor SF is a value for controlling luminance of the display panel 110. The scale factor SF may have a value between 0 and 1. As the scale factor SF decreases, the luminance of the display panel 110 may decrease.

In an embodiment, as shown in FIGS. 4A and 4B, the scale factor SF may be determined based on a net power control graph indicating a correlation between the scale factor SF and the load ILD of the input frame data IFD.

For example, FIG. 4A shows a net power control graph for a global luminance control (i.e., indicated as GLOBAL GAIN), and FIG. 4B shows a net power control graph for a peak luminance control (i.e., indicated as PEAK CLIPPING). Here, the scale factor SF may decrease as the load ILD of the input frame data IFD increases beyond a reference load RV in the net power control graph, i.e., when the load ILD of the input frame data IFD is greater than the reference load RV in the net power control graph. However, the net power control graph and its application are not limited thereto.

Based on the net power control graph, the net power control block 152 may lower the scale factor SF closer to 0 as the load ILD of the input frame data IFD increases to significantly reduce the luminance of the display panel 110 and may increase the scale factor SF closer to 1 as the load ILD of the input frame data IFD decreases to slightly reduce the luminance of the display panel 110. To this end, the net power control block 152 may perform the global luminance control (i.e., indicated as GLOBAL GAIN) and/or the peak luminance control (i.e., indicated as PEAK CLIPPING).

Once the scale factor SF is determined, the net power control block 152 may apply the scale factor SF to the input frame data IFD (e.g., by multiplying the input frame data IFD by the scale factor SF) to generate the output frame data OFD, may analyze the output frame data OFD to determine the load (LD in FIG. 3) of the output frame data OFD, and may provide the load LD of the output frame data OFD to the power supply voltage varying block 153.

The power supply voltage varying block 153 may receive the maximum grayscale MG of the input frame data IFD and the load LD of the output frame data OFD, may determine the first power supply voltage ELVDD based on the maximum grayscale MG of the input frame data IFD and the load LD of the output frame data OFD, and may output the first power supply voltage code EC indicating the determined first power supply voltage ELVDD.

In an embodiment, as shown in FIGS. 5A and 5B, the first power supply voltage ELVDD may be determined based on a power supply voltage variation graph indicating a correlation among the first power supply voltage ELVDD, the load LD of the output frame data OFD, and the maximum grayscale MG of the input frame data IFD. That is, the first power supply voltage ELVDD may vary within an entire voltage varying range (i.e., indicated as ELVDD VARYING RANGE) that is determined based on the load LD of the output frame data OFD and the maximum grayscale MG of the input frame data IFD.

The first power supply voltage ELVDD may increase as the maximum grayscale MG of the input frame data IFD increases and as the load LD of the output frame data OFD increases in the power supply voltage variation graph.

In an embodiment, in a case where the load LD of the output frame data OFD is the same or constant, the first power supply voltage ELVDD may increase as the maximum grayscale MG of the input frame data IFD increases. In an embodiment, for example, when the load LD of the output frame data OFD corresponds to a maximum load condition MAXLC, the first power supply voltage ELVDD may be determined based on the maximum grayscale MG of the input frame data IFD on a line indicating the maximum load condition MAXLC. In an embodiment, when the load LD of the output frame data OFD corresponds to a minimum load condition MINLC, the first power supply voltage ELVDD may be determined based on the maximum grayscale MG of the input frame data IFD on a line indicating the minimum load condition MINLC.

In an embodiment, in a case where the maximum grayscale MG of the input frame data IFD is the same or constant, the first power supply voltage ELVDD may increase as the load LD of the output frame data OFD increases. In an embodiment example, when the maximum grayscale MG of the input frame data IFD is the same, the line indicating the maximum load condition MAXLC has a higher voltage value than the line indicating the minimum load condition MINLC, such a voltage varying range (i.e., indicated as TR) due to the load LD of the output frame data OFD may exist.

In an embodiment, for example, as shown in FIG. 5B, an image (a) has low grayscales overall, such the load LD of the output frame data OFD is low (i.e., indicated as LOW), and the maximum grayscale MG of the input frame data IFD is also low (i.e., indicated as LOW). Thus, the power supply voltage varying block 153 may determine the first power supply voltage ELVDD to be 14 volts (V) that is relatively low by using the power supply voltage variation graph.

In an image (b), some grayscales are very high while others are very low, so the load LD of the output frame data OFD is medium (i.e., indicated as MID), and the maximum grayscale MG of the input frame data IFD is high (i.e., indicated as HIGH). Thus, the power supply voltage varying block 153 may determine the first power supply voltage ELVDD to be 24 V that is relatively high by using the power supply voltage variation graph.

In an image (c), although all grayscales are lower than some grayscales of the (b) image, all grayscales are relatively high overall. That is, the load LD of the output frame data OFD is high (i.e., indicated as HIGH), and the maximum grayscale MG of the input frame data IFD is medium (i.e., indicated as MID). Thus, the power supply voltage varying block 153 may determine the first power supply voltage ELVDD to be 18 V that is relatively medium by using the power supply voltage variation graph.

The input power supply voltage determining block 154 may receive the first power supply voltage code EC from the power supply voltage varying block 153, may determine the input power supply voltage VDD that can achieve an optimal buck-converting efficiency for generating the first power supply voltage ELVDD based on the first power supply voltage code EC, and may output the input power supply voltage code VC indicating the determined input power supply voltage VDD.

In an embodiment, the input power supply voltage determining block 154 may determine the input power supply voltage VDD to be higher than the first power supply voltage ELVDD by a predetermined voltage AV (e.g., 5 V). In an embodiment, when the first power supply voltage ELVDD is determined to be 26.4 V, the input power supply voltage VDD may be determined to be 26.4 V+AV. In an embodiment, when the first power supply voltage ELVDD is determined to be 18.5 V, the input power supply voltage VDD may be determined to be 18.5 V+AV.

The input power supply voltage DAC block 141 may receive the input power supply voltage code VC from the input power supply voltage determining block 154 and may convert the input power supply voltage code VC in a digital form to an input power supply DAC voltage VDV in an analog form. In such an embodiment, the input power supply voltage DAC block 141 may include a digital-analog converter.

The input power supply voltage generating block 142 may receive the input power supply DAC voltage VDV from the input power supply voltage DAC block 141 and may generate the input power supply voltage VDD using an external power supply voltage EPV (e.g., an AC voltage, a battery voltage, etc) and the input power supply DAC voltage VDV. In an embodiment, the input power supply voltage generating block 142 may include a buck converter. Thus, the external power supply voltage EPV may be applied as an input voltage of the buck converter, and the input power supply voltage VDD may be generated (i.e., output) as an output voltage of the buck converter when the input power supply DAC voltage VDV is applied to a feedback circuit of the buck converter.

The first power supply voltage DAC block 143 may receive the first power supply voltage code EC from the power supply voltage varying block 153 and may convert the first power supply voltage code EC in a digital form to a first power supply DAC voltage EDV in an analog form. In an embodiment, the first power supply voltage DAC block 143 may include a digital-analog converter.

The first power supply voltage generating block 144 may receive the first power supply DAC voltage EDV from the first power supply voltage DAC block 143, may receive the input power supply voltage VDD from the input power supply voltage generating block 142, and may generate the first power supply voltage ELVDD using the input power supply voltage

VDD and the first power supply DAC voltage EDV. In an embodiment, the first power supply voltage generating block 144 may include a buck converter. Thus, the input power supply voltage VDD may be applied as an input voltage of the buck converter, and the first power supply voltage ELVDD may be generated (i.e., output) as an output voltage of the buck converter when the first power supply DAC voltage EDV is applied to a feedback circuit of the buck converter.

In an embodiment, as described above, the display device 100 may include the display panel 110 including the pixels 111, the gate driving circuit 120 that provides the gate signal GS to the display panel 110, the data driving circuit 130 that provides the data signal DS to the display panel 110, the driving voltage supplying circuit 140 that supplies the gate driving voltage GDV to the gate driving circuit 120, the data driving voltage DDV to the data driving circuit 130, and the panel driving voltage PDV including the first power supply voltage ELVDD and the second power supply voltage ELVSS lower than the first power supply voltage ELVDD to the display panel 110, and the driving control circuit 150 that controls the gate driving circuit 120, the data driving circuit 130, and the driving voltage supplying circuit 140. In such an embodiment, by controlling the driving control circuit 150 to determine the scale factor SF based on the load ILD of the input frame data IFD, to generate the output frame data OFD by applying the scale factor SF to the input frame data IFD, and to determine the first power supply voltage ELVDD and the input power supply voltage VDD for generating the first power supply voltage ELVDD based on the maximum grayscale MG of the input frame data IFD and the load LD of the output frame data OFD, the display device 100 may optimize the buck-converting efficiency according to the input power supply voltage VDD with respect to the first power supply voltage generating block 144 included in the driving voltage supplying circuit 140 to efficiently reduce undesired power consumption of the driving voltage supplying circuit 140 when performing the net power control function and the variable power supply voltage function.

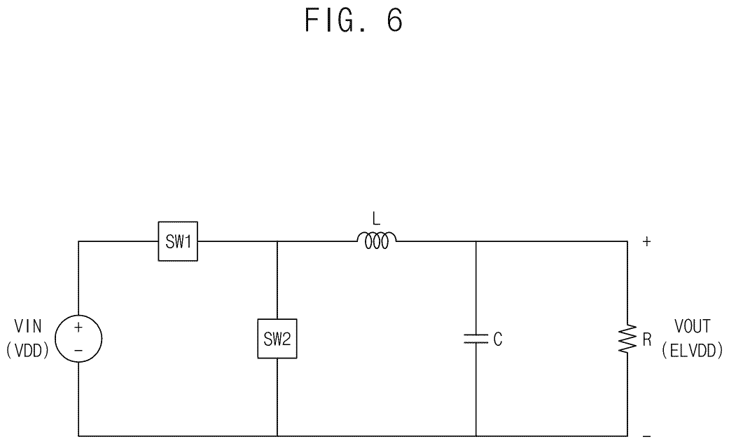

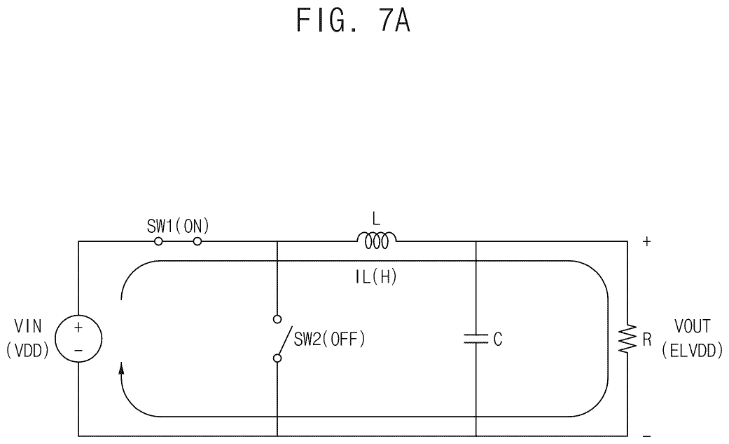

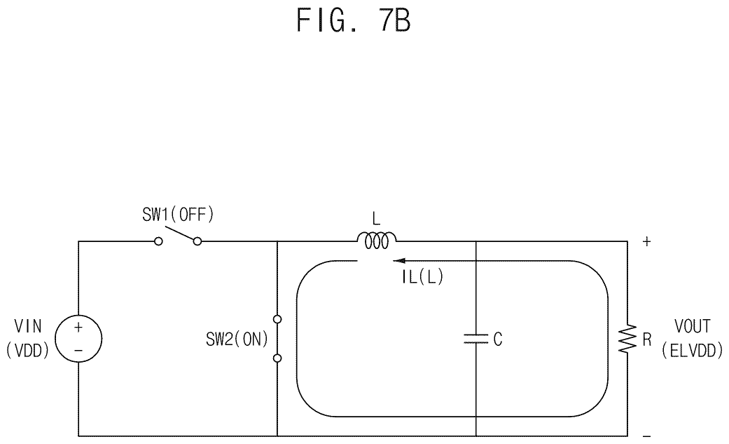

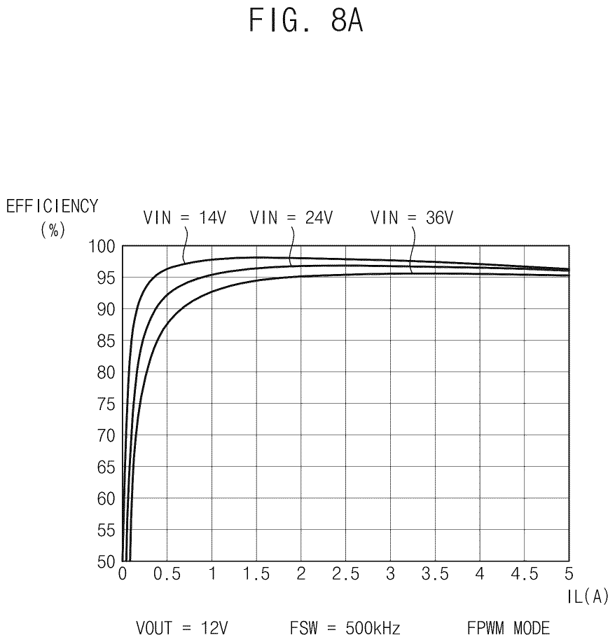

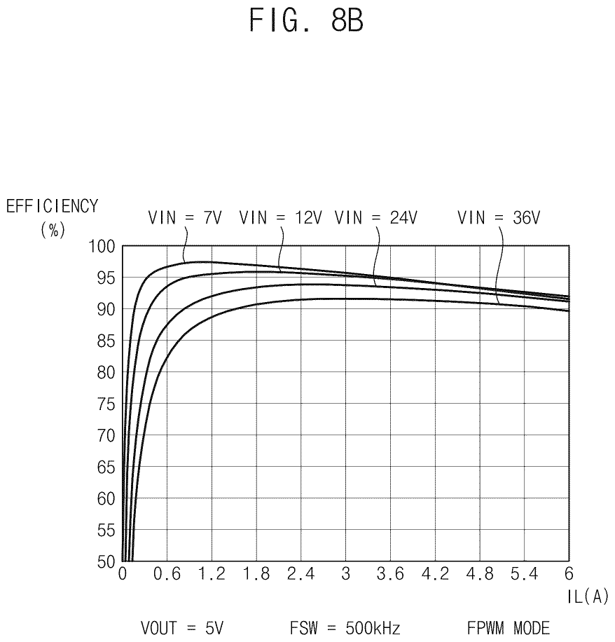

FIG. 6 is a circuit diagram illustrating an example of a first power supply voltage generating block included in the display device of FIG. 1, FIGS. 7A and 7B are diagrams for describing an operation of the first power supply voltage generating block of FIG. 6, and FIGS. 8A and 8B are graphs for describing a buck-converting efficiency according to an input power supply voltage with respect to the first power supply voltage generating block of FIG. 6.

Referring to FIGS. 6 to 8B, in an embodiment, the first power supply voltage generating block 144 may include a buck converter. The buck converter may include a first switch SW1, a second switch SW2, an inductor L, a capacitor C, and a resistor R. Although not shown, the buck converter may further include a feedback circuit that controls complementary turn-on/turn-off of the first and second switches SW1 and SW2.

In an embodiment, for example, the feedback circuit may include a voltage divider that generates a feedback voltage by voltage-dividing an output voltage VOUT of the buck converter, a comparator that compares the feedback voltage with a reference voltage, which is the first power supply DAC voltage EDV, to generate an error signal, a controller that adjusts a duty cycle of a pulse width modulation (PWM) signal for controlling the first and second switches SW1 and SW2 based on the error signal, a stabilizer that stabilizes a feedback loop, etc. However, the feedback circuit is not limited thereto. That is, the feedback circuit may be variously designed in relation to basic components of the buck converter (i.e., the first switch SW1, the second switch SW2, the inductor L, the capacitor C, and the resistor R).

The input power supply voltage VDD may be applied as an input voltage VIN, the first power supply DAC voltage EDV may be applied as a reference voltage, and thus the first power supply voltage ELVDD may be output as the output voltage VOUT across the resistor R and the capacitor C.

As shown in FIG. 7A, when the first switch SW1 is turned on and the second switch SW2 is turned off, an inductor current IL (H) may flow through the inductor L, and a current proportional to the inductor current IL(H) may flow through the resistor R. As a result, a voltage across the resistor R and the capacitor C may increase.

On the other hand, as shown in FIG. 7B, when the first switch SW1 is turned off and the second switch SW2 is turned on, an inductor current IL(L) may flow through the inductor L, and a current proportional to the inductor current IL(L) may flow through the resistor R. As a result, the voltage across the resistor R and the capacitor C may decrease.

Here, a ratio of increase and decrease in the voltage across the resistor R and the capacitor C may be determined by the duty cycle of the PWM signal for controlling the first and second switches SW1 and SW2, and thus the voltage across the resistor R and the capacitor C may be determined. That is, the first power supply voltage ELVDD generated by buck-converting the input power supply voltage VDD may be lower than the input power supply voltage VDD.

In such an embodiment, as described above, the input voltage VIN, which is the input power supply voltage VDD, may be buck-converted into the output voltage VOUT, which is the first power supply voltage ELVDD, by the complementary turn-on/turn-off of the first and second switches SW1 and SW2. However, a switching loss (i.e., a reduction of the buck-converting efficiency) due to switching operations (i.e., the complementary turn-on/turn-off) of the first and second switches SW1 and SW2 may occur.

As shown in FIGS. 8A and 8B, the greater the input voltage VIN of the buck converter (i.e., the input power supply voltage VDD) is as compared to the output voltage VOUT of the buck converter (i.e., the first power supply voltage ELVDD), the lower the buck-converting efficiency according to the input power supply voltage VDD with respect to the first power supply voltage generating block 144 may be.

For example, as shown in FIG. 8A, when the output voltage VOUT, which is the first power supply voltage ELVDD, is 12 V, the switching frequency FSW is 500 kilohertz (kHz), and the forced pulse width modulation (FPWM) mode that turns on and off switches at a fixed speed regardless of a load condition is used, the greater the input voltage VIN (i.e., the input power supply voltage VDD) is (e.g., 14 V, 24 V, 36 V in that order), the lower the buck-converting efficiency may be.

In another example, as shown in FIG. 8B, when the output voltage VOUT, which is the first power supply voltage ELVDD, is 5 V, the switching frequency FSW is 500 kHz, and the FPWM mode is used, the greater the input voltage VIN (i.e., the input power supply voltage VDD) is (e.g., 7 V, 12 V, 24 V, 36 V in that order), the lower the buck-converting efficiency may be.

Therefore, the driving control circuit 150 may set the input power supply voltage VDD to be a voltage that can achieve an optimal buck-converting efficiency (i.e., a voltage higher than the first power supply voltage ELVDD by a predetermined voltage), and the driving voltage supplying circuit 140 may buck-convert the input power supply voltage VDD, which is set to be the voltage that can achieve the optimal buck-converting efficiency, to generate the first power supply voltage ELVDD.

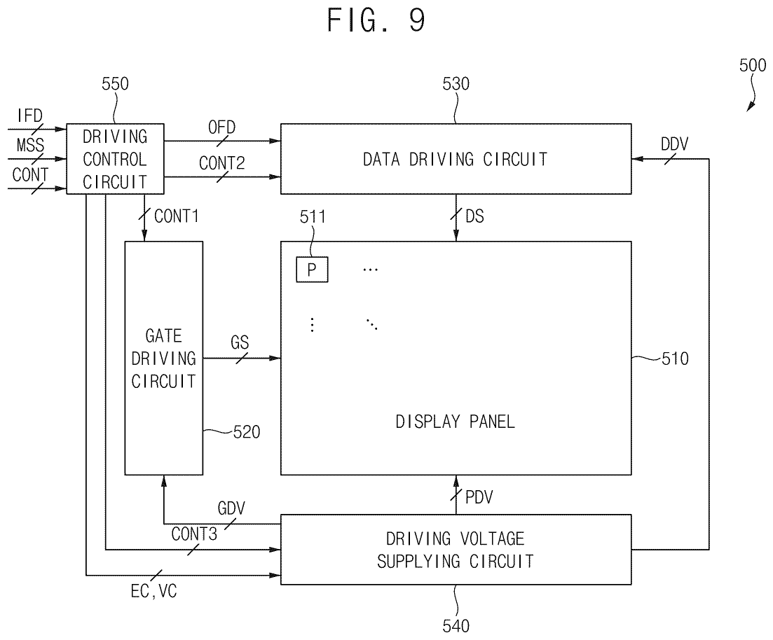

FIG. 9 is a block diagram illustrating a display device according to embodiments.

Referring to FIG. 9, an embodiment of the display device 500 may include a display panel 510, a gate driving circuit 520, a data driving circuit 530, a driving voltage supplying circuit 540, and a driving control circuit 550. In such an embodiment, the display device 500 is substantially the same as the display device 100 of FIG. 1 except for configurations and operations of the driving voltage supplying circuit 540 and the driving control circuit 550, any repetitive detailed description of the same or like elements as those described above will be omitted or simplified.

In an embodiment, the display panel 510 may include gate lines, data lines, and pixels 111 electrically connected to the gate lines and the data lines. The gate lines may extend in a first direction, and the data lines may extend in a second direction intersecting the first direction.

In such an embodiment, the display panel 510 may selectively operate in a high-brightness mode having a first dynamic range (e.g., also referred to as a high dynamic range (HDR) mode) or a low-brightness mode having a second dynamic range narrower than the first dynamic range (e.g., also referred to as a standard dynamic range (SDR) mode).

In an embodiment, for example, the high-brightness mode of the display panel 510 may be a brightness mode in which a maximum luminance of the display panel 510 corresponds to a luminance corresponding to a maximum grayscale of the input frame data IFD, and the low-brightness mode may be a brightness mode in which a limited luminance set according to a predetermined condition corresponds to the luminance corresponding to the maximum grayscale of the input frame data IFD.

The driving voltage supplying circuit 540 may supply a gate driving voltage GDV to the gate driving circuit 520, supply a data driving voltage DDV to the data driving circuit 530, and supply a panel driving voltage PDV including a first power supply voltage ELVDD and a second power supply voltage ELVSS to the display panel 510. In some embodiments, the panel driving voltage PDV may further include an initialization (or reset) voltage applied to the pixels 111 included in the display panel 510 and the like.

The driving voltage supplying circuit 540 may generate an input power supply voltage for generating the first power supply voltage ELVDD and the first power supply voltage ELVDD based on a third control signal CONT3, a first power supply voltage code EC, and an input power supply voltage code VC provided from the driving control circuit 550. In some embodiments, the third control signal CONT3 may include the first power supply voltage code EC and the input power supply voltage code VC.

in an embodiment, the driving voltage supplying circuit 540 may generate the input power supply voltage using an external power supply voltage (e.g., an AC voltage, a battery voltage, etc) and then may generate the first power supply voltage ELVDD using the generated input power supply voltage. Detailed description thereof will be provided below.

The driving control circuit 550 may control the gate driving circuit 520, the data driving circuit 530, and the driving voltage supplying circuit 540. In such an embodiment, the driving control circuit 550 may provide a first control signal CONT1 to the gate driving circuit 520, a second control signal CONT2 to the data driving circuit 530, and the third control signal CONT3 to the driving voltage supplying circuit 540 to control the gate driving circuit 520, the data driving circuit 530, and the driving voltage supplying circuit 540.

The driving control circuit 550 may receive input frame data IFD and an input control signal CONT from a host processor (e.g., a GPU, etc). The input control signal CONT may include a master clock signal and a data enable signal. In some embodiments, the input control signal CONT may further include a vertical sync signal and a horizontal sync signal. In addition, the driving control circuit 550 may receive a brightness mode signal MSS indicating the brightness mode of the display panel 510 from other components.

The driving control circuit 550 may receive the input frame data IFD and the input control signal CONT and may generate the first control signal CONT1, the second control signal CONT2, the third control signal CONT3, and output frame data OFD based on the input frame data IFD and the input control signal CONT.

In an embodiment, the driving control circuit 550 may generate the first control signal CONT1 for controlling an operation of the gate driving circuit 520 to output the first control signal CONT to the gate driving circuit 520, may generate the second control signal CONT2 for controlling an operation of the data driving circuit 530 to output the second control signal CONT2 to the data driving circuit 530, and may generate the third control signal CONT3 for controlling an operation of the driving voltage supplying circuit 540 to output the third control signal CONT3 to the driving voltage supplying circuit 540.

The driving control circuit 550 may generate the output frame data OFD based on the input frame data IFD and may output the output frame data OFD to the data driving circuit 530. The output frame data OFD may be generated by applying a scale factor to the input frame data IFD (e.g., by multiplying the input frame data IFD by the scale factor having a value between 0 and 1). In some embodiments, the output frame data OFD may be generated by additionally performing a specific processing (e.g., degradation compensation, etc) on the input frame data IFD.

In embodiments, the driving control circuit 550 may perform a net power control function and a variable power supply voltage function. In an embodiment, to perform the net power control function and the variable power supply voltage function, the driving control circuit 550 may determine the scale factor based on a load of the input frame data IFD, may generate the output frame data OFD by applying the scale factor to the input frame data IFD, and may determine the first power supply voltage ELVDD and the input power supply voltage for generating the first power supply voltage ELVDD based on the brightness mode of the display panel 510.

In such an embodiment, when the brightness mode of the display panel 510 is the high-brightness mode having the first dynamic range, the driving control circuit 550 may determine a first set voltage FSV as the first power supply voltage ELVDD. In such an embodiment, when the brightness mode of the display panel 510 is the low-brightness mode having the second dynamic range narrower than the first dynamic range, the driving control circuit 550 may determine a second set voltage SSV that is lower than the first set voltage FSV as the first power supply voltage ELVDD. Detailed description thereof will be provided below.

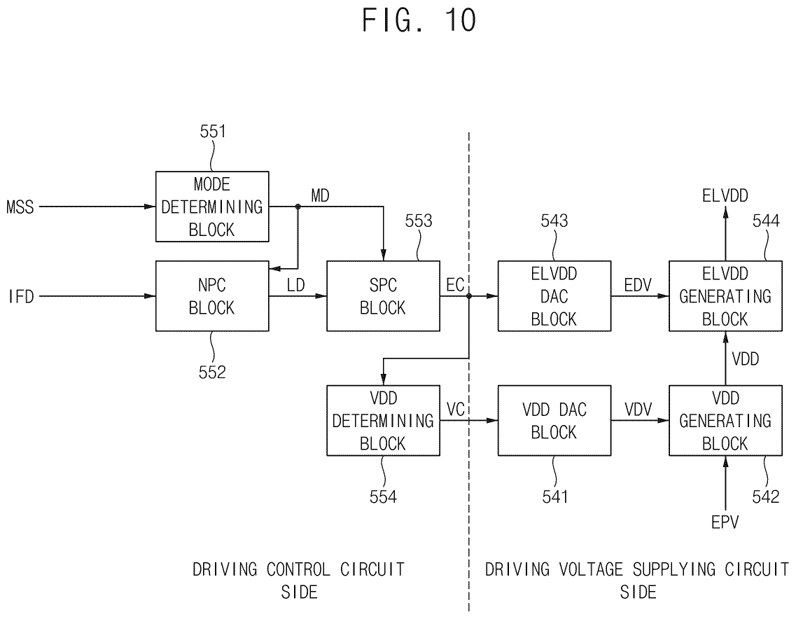

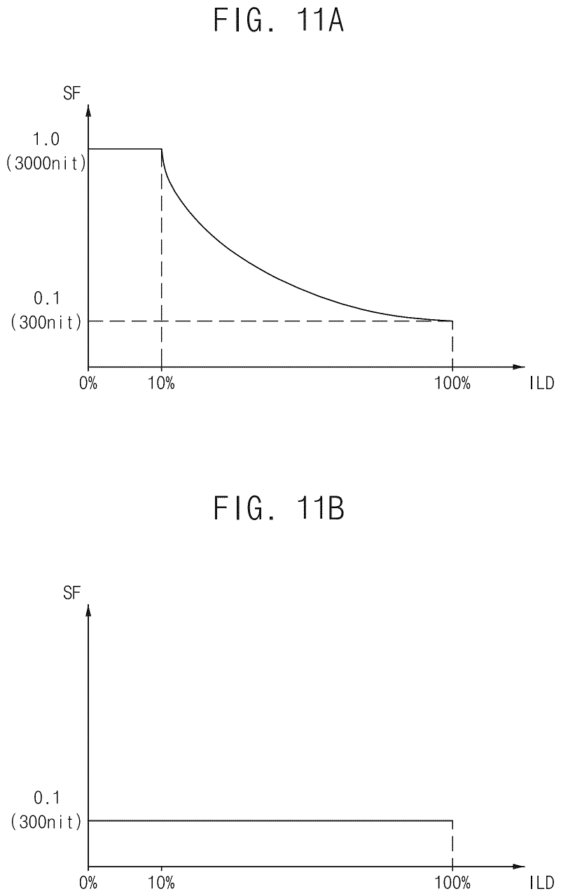

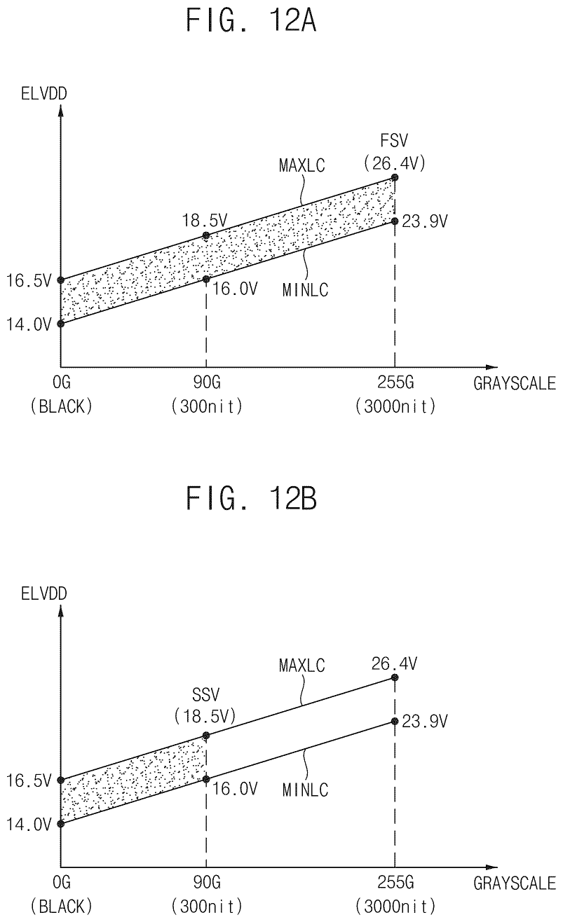

FIG. 10 is a block diagram for describing a net power control function and a variable power supply voltage function performed by the display device of FIG. 9, FIGS. 11A and 11B are diagrams illustrating an example in which the display device of FIG. 9 performs a net power control function, and FIGS. 12A and 12B are diagrams illustrating an example in which the display device of FIG. 9 performs a variable power supply voltage function.

Referring to FIGS. 10 to 12B, FIG. 10 illustrates components for performing the net power control function and the variable power supply voltage function. These components may include a mode determining block 551, a net power control block 552, a power supply voltage varying block 553, an input power supply voltage determining block 554, an input power supply voltage digital-analog converting (DAC) block 541, an input power supply voltage generating block 542, a first power supply voltage DAC block 543, and a first power supply voltage generating block 544.

In an embodiment, as shown in FIG. 10, the mode determining block 551, the net power control block 552, the power supply voltage varying block 553, and the input power supply voltage determining block 554 may be included in (or defined by blocks of) the driving control circuit 550, and the input power supply voltage DAC block 541, the input power supply voltage generating block 542, the first power supply voltage DAC block 543, and the first power supply voltage generating block 544 may be included in (or defined by blocks of) the driving voltage supplying circuit 540.

The mode determining block 551 may receive the brightness mode signal MSS and may detect a brightness mode MD of the display panel 510 indicated by the brightness mode signal MSS. The mode determining block 551 may provide the brightness mode MD of the display panel 510 to the power supply voltage varying block 553.

The net power control block 552 may receive the input frame data IFD and may analyze the input frame data IFD to determine the load (ILD in FIGS. 11A and 11B) of the input frame data IFD (e.g., by summing all grayscales of the input frame data IFD, etc).

The load ILD of the input frame data IFD may be in a range from 0% to 100%. In an embodiment, for example, when the input frame data IFD displays a full black image, the load ILD of the input frame data IFD may be 0%, and when the input frame data IFD displays a full white image, the load ILD of the input image data IFD may be 100%.

The net power control block 552 may determine the scale factor SF based on the load ILD of the input frame data IFD. The scale factor SF is a value for controlling luminance of the display panel 510. The scale factor SF may have a value between 0 and 1. As the scale factor SF decreases, the luminance of the display panel 510 may decrease.

In an embodiment, the scale factor SF may be determined based on a first net power control graph indicating a first correlation between the scale factor SF and the load ILD of the input frame data IFD when the brightness mode MD of the display panel 510 is the high-brightness mode. In such an embodiment, the scale factor SF may be determined based on a second net power control graph indicating a second correlation between the scale factor SF and the load ILD of the input frame data IFD when the brightness mode MD of the display panel 510 is the low-brightness mode.

FIG. 11A illustrates an example of the first net power control graph used when the brightness mode MD of the display panel 510 is the high-brightness mode. The scale factor SF may decrease as the load ILD of the input frame data IFD increases beyond a reference load RV in the first net power control graph, that is, when the load ILD of the input frame data IFD is greater than the reference load RV in the first net power control graph. That is, the scale factor SF may have a value between 0 and 1, and the display panel 510 may implement a maximum luminance of 3000 nits. However, the first net power control graph and its application are not limited thereto.

FIG. 11B illustrates an example of the second net power control graph used when the brightness mode MD of the display panel 510 is the low-brightness mode. The scale factor SF may have a predetermined fixed value (e.g., 0.1) regardless of the load ILD of the input frame data IFD in the second net power control graph. That is, the scale factor SF may be fixed to be 0.1, and the display panel 510 may implement a maximum luminance of 300 nits. However, the second net power control graph and its application are not limited thereto.

Once the scale factor SF is determined, the net power control block 552 may apply the scale factor SF to the input frame data IFD (e.g., by multiplying the input frame data IFD by the scale factor SF) to generate the output frame data OFD, may analyze the output frame data OFD to determine the load LD of the output frame data OFD, and may provide the load LD of the output frame data OFD to the power supply voltage varying block 553.

The power supply voltage varying block 553 may receive the brightness mode MD of the display panel 510 and the load LD of the output frame data OFD, may determine the first power supply voltage ELVDD based on the brightness mode MD of the display panel 510 and the load LD of the output frame data OFD, and may output the first power supply voltage code EC indicating the determined first power supply voltage ELVDD.

In an embodiment, as shown in FIGS. 12A and 12B, the first power supply voltage ELVDD may be determined based on a power supply voltage varying graph indicating a correlation among the first power supply voltage ELVDD, the load LD of the output frame data OFD, and a luminance usage range of the brightness mode MD of the display panel 510. The luminance usage range of the brightness mode MD of the display panel 510 may vary depending on the scale factor SF. That is, the greater the scale factor SF is, the wider the luminance usage range of the brightness mode MD of the display panel 510 is.

In an embodiment, for example, as shown in FIGS. 12A and 12B, the luminance usage range of the high-brightness mode of the display panel 510 may be between 0 nits and 3000 nits, and the corresponding usage range of the first power supply voltage ELVDD may be between 14 V and 26.6 V. In addition, as shown in FIG. 12B, the luminance usage range of the low-brightness mode of the display panel 510 may be between 0 nits and 300 nits, and the corresponding usage range of the first power supply voltage ELVDD may be between 14 V and 18.5 V.

In an embodiment, as shown in FIG. 12A, the power supply voltage varying block 553 may determine a first set voltage FSV as the first power supply voltage ELVDD when the brightness mode MD of the display panel 510 is the high-brightness mode having the first dynamic range. That is, the first set voltage FSV (e.g., 26.4 V in FIG. 12A) required for the maximum luminance implemented by the display panel 510 (e.g., 3000 nits corresponding to the 255th-grayscale when the load LD of the output frame data OFD corresponds to a maximum load condition MAXLC in FIG. 12A) when the brightness mode MD of the display panel 510 is the high-brightness mode may be determined as the first power supply voltage ELVDD.

In addition, as shown in FIG. 12B, the power supply voltage varying block 553 may determine a second set voltage SSV as the first power supply voltage ELVDD when the brightness mode MD of the display panel 510 is the low-brightness mode having a second dynamic range. That is, the second set voltage SSV (e.g., 18.5 V in FIG. 12B) required for the maximum luminance implemented by the display panel 510 (e.g., 300 nits corresponding to the 90th-grayscale when the load LD of the output frame data OFD corresponds to the maximum load condition MAXLC in FIG. 12B) when the brightness mode MD of the display panel 510 is the low-brightness mode may be determined as the first power supply voltage ELVDD.

The input power supply voltage determining block 554 may receive the first power supply voltage code EC from the power supply voltage varying block 553, may determine the input power supply voltage VDD that can achieve an optimal buck-converting efficiency for generating the first power supply voltage ELVDD based on the first power supply voltage code EC, and may output the input power supply voltage code VC indicating the determined input power supply voltage VDD.

In an embodiment, the input power supply voltage determining block 554 may determine the input power supply voltage VDD to be higher than the first power supply voltage ELVDD by a predetermined voltage AV (e.g., 5 V). In an embodiment, when the first power supply voltage ELVDD is determined to be 26.4 V, the input power supply voltage VDD may be determined to be 26.4 V+AV. In an embodiment, when the first power supply voltage ELVDD is determined to be 18.5 V, the input power supply voltage VDD may be determined to be 18.5 V+AV.

The input power supply voltage DAC block 541 may receive the input power supply voltage code VC from the input power supply voltage determining block 554 and may convert the input power supply voltage code VC in a digital form to an input power supply DAC voltage VDV in an analog form. To this end, the input power supply voltage DAC block 541 may include a digital-analog converter.

The input power supply voltage generating block 542 may receive the input power supply DAC voltage VDV from the input power supply voltage DAC block 541 and may generate the input power supply voltage VDD using an external power supply voltage EPV (e.g., an AC voltage, a battery voltage, etc) and the input power supply DAC voltage VDV. To this end, the input power supply voltage generating block 542 may include a buck converter. Thus, the external power supply voltage EPV may be applied as an input voltage of the buck converter, and the input power supply voltage VDD may be generated (i.e., output) as an output voltage of the buck converter as the input power supply DAC voltage VDV is applied to a feedback circuit of the buck converter.

The first power supply voltage DAC block 543 may receive the first power supply voltage code EC from the power supply voltage varying block 553 and may convert the first power supply voltage code EC in a digital form to a first power supply DAC voltage EDV in an analog form. To this end, the first power supply voltage DAC block 543 may include a digital-analog converter.

The first power supply voltage generating block 544 may receive the first power supply DAC voltage EDV from the first power supply voltage DAC block 543, may receive the input power supply voltage VDD from the input power supply voltage generating block 542, and may generate the first power supply voltage ELVDD using the input power supply voltage VDD and the first power supply DAC voltage EDV. To this end, the first power supply voltage generating block 544 may include a buck converter. Thus, the input power supply voltage VDD may be applied as an input voltage of the buck converter, and the first power supply voltage ELVDD may be generated (i.e., output) as an output voltage of the buck converter as the first power supply DAC voltage EDV is applied to a feedback circuit of the buck converter.

In an embodiment, as described above, the display device 500 may include the display panel 510 including the pixels 511, the gate driving circuit 520 that provides the gate signal GS to the display panel 510, the data driving circuit 530 that provides the data signal DS to the display panel 510, the driving voltage supplying circuit 540 that supplies the gate driving voltage GDV to the gate driving circuit 520, the data driving voltage DDV to the data driving circuit 530, and the panel driving voltage PDV including the first power supply voltage ELVDD and the second power supply voltage ELVSS lower than the first power supply voltage ELVDD to the display panel 510, and the driving control circuit 550 that controls the gate driving circuit 520, the data driving circuit 530, and the driving voltage supplying circuit 540. In such an embodiment, by controlling the driving control circuit 550 to determine the scale factor SF based on the load ILD of the input frame data IFD, to generate the output frame data OFD by applying the scale factor SF to the input frame data IFD, and to determine the first power supply voltage ELVDD and the input power supply voltage VDD for generating the first power supply voltage ELVDD based on the brightness mode MD of the display panel 510, the display device 500 may optimize the buck-converting efficiency according to the input power supply voltage VDD with respect to the first power supply voltage generating block 544 included in the driving voltage supplying circuit 540 to efficiently reduce undesired power consumption of the driving voltage supplying circuit 540 when performing the net power control function and the variable power supply voltage function.

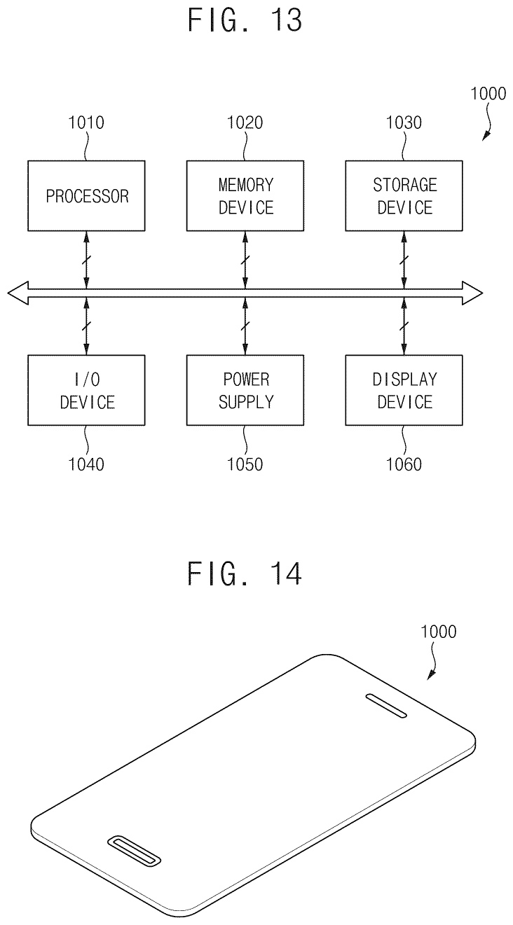

FIG. 13 is a block diagram illustrating an electronic device according to embodiments, and FIG. 14 is a diagram illustrating an example in which the electronic device of FIG. 13 is implemented as a smartphone.

Referring to FIGS. 13 and 14, an embodiment of the electronic device 1000 may include a processor 1010, a memory device 1020, a storage device 1030, an input/output (I/O) device 1040, a power supply 1050, and a display device 1060. In such an embodiment, the display device 1060 may be the display device 100 of FIG. 1 or the display device 500 of FIG. 9.

The electronic device 1000 may further include a plurality of ports for communicating with a video card, a sound card, a memory card, a universal serial bus (USB) device, other electronic devices, etc.

In an embodiment, as shown in FIG. 14, the electronic device 1000 may be implemented as a smart phone. However, the electronic device 1000 is not limited thereto. For example, the electronic device 1000 may be implemented as a cellular phone, a video phone, a smart pad, a smart watch, a tablet personal computer (PC), a car navigation system, a computer monitor, a laptop, a head mounted display (HMD) device, etc.

The processor 1010 may perform various computing functions. In an embodiment, the processor 1010 may perform rendering on image data (i.e., input frame data) corresponding to an image that the display device 1060 displays on a display panel.

The processor 1010 may be a micro processor, a central processing unit (CPU), an application processor (AP), a graphic processing unit (GPU), etc.

The processor 1010 may be coupled to other components via an address bus, a control bus, a data bus, etc. Further, the processor 1010 may be coupled to an extended bus such as a peripheral component interconnection (PCI) bus.

The memory device 1020 may store data for operations of the electronic device 1000.

For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc and/or at least one volatile memory device such as a dynamic random access memory (DRAM) device, a static random access memory (SRAM) device, a mobile DRAM device, etc.

The storage device 1030 may include a solid state drive (SSD) device, a hard disk drive (HDD) device, a CD-ROM device, etc.

The I/O device 1040 may include an input device such as a keyboard, a keypad, a mouse device, a touch-pad, a touch-screen, etc, and an output device such as a printer, a speaker, etc. In some embodiments, the I/O device 1040 may include the display device 1060.

The power supply 1050 may provide power for operations of the electronic device 1000. In some embodiments, a driving voltage generating circuit included in the display device 1060 may be implemented as a part of the power supply 1050 or may be implemented as a component independent of the power supply 1050.

The display device 1060 may display an image corresponding to visual information of the electronic device 1000. The display device 1060 may be connected to other components through the buses or other communication links.

In an embodiment, the display device 1060 may employ (or adopt) a net power control function for adjusting a luminance of the display panel by applying a scale factor to input frame data under predetermined conditions and a variable power supply voltage function for varying a first power supply voltage under predetermined conditions.

In such an embodiment, the display device 1060 may optimize a buck-converting efficiency according to an input power supply voltage with respect to a first power supply voltage generating block within a driving voltage supplying circuit to efficiently reduce unnecessary power consumption of the driving voltage supplying circuit when performing the net power control function and the variable power supply voltage function.

In an embodiment, the display device 1060 may display an image corresponding to output frame data generated by applying the scale factor to the input frame data on the display panel and may vary the first power supply voltage applied to the display panel and the input power supply voltage for generating the first power supply voltage based on a maximum grayscale of the input frame data and a load of the output frame data.

In such an embodiment, the display device 1060 may include the display panel including pixels, a gate driving circuit that provides a gate signal to the display panel, a data driving circuit that provides a data signal to the display panel, a driving voltage supplying circuit that supplies a gate driving voltage to the gate driving circuit, a data driving voltage to the data driving circuit, and a panel driving voltage including the first power supply voltage and a second power supply voltage lower than the first power supply voltage to the display panel, and a driving control circuit that controls the gate driving circuit, the data driving circuit, and the driving voltage supplying circuit. In such an embodiment, the display device 1060 may control the driving control circuit to determine the scale factor based on the load of the input frame data, to generate the output frame data by applying the scale factor to the input frame data, and to determine the first power supply voltage and the input power supply voltage for generating the first power supply voltage based on the maximum grayscale of the input frame data and the load of the output frame data.

In another embodiment, the display device 1060 may display the image corresponding to the output frame data generated by applying the scale factor to the input frame data on the display panel and may vary the first power supply voltage applied to the display panel and the input power supply voltage for generating the first power supply voltage based on a brightness mode of the display panel.

In such an embodiment, the display device 1060 may include the display panel including pixels, a gate driving circuit that provides a gate signal to the display panel, a data driving circuit that provides a data signal to the display panel, a driving voltage supplying circuit that supplies a gate driving voltage to the gate driving circuit, a data driving voltage to the data driving circuit, and a panel driving voltage including the first power supply voltage and a second power supply voltage lower than the first power supply voltage to the display panel, and a driving control circuit that controls the gate driving circuit, the data driving circuit, and the driving voltage supplying circuit. In such an embodiment, the display device 1060 may control the driving control circuit to determine the scale factor based on the load of the input frame data, to generate the output frame data by applying the scale factor to the input frame data, and to determine the first power supply voltage and the input power supply voltage for generating the first power supply voltage based on the brightness mode of the display panel.

Since the display device 1060 is substantially the same as those described above, any repetitive detailed description thereof will be omitted or simplified.

Embodiments of the present disclosure may be applied to a display device and an electronic device including the display device, for example, a smart phone, a cellular phone, a video phone, a smart pad, a smart watch, a tablet PC, a car navigation system, a television, a computer monitor, a laptop, a digital camera, a head mounted display device, etc.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A display device comprising:
a display panel including pixels;
a gate driving circuit which provides a gate signal to the display panel;
a data driving circuit which provides a data signal to the display panel;
a driving voltage supplying circuit which supplies a gate driving voltage to the gate driving circuit, supplies a data driving voltage to the data driving circuit, and supplies a panel driving voltage including a first power supply voltage and a second power supply voltage lower than the first power supply voltage to the display panel; and
a driving control circuit which controls the gate driving circuit, the data driving circuit, and the driving voltage supplying circuit,
wherein the driving control circuit determines a scale factor based on a load of input frame data, generates output frame data by applying the scale factor to the input frame data, and determines the first power supply voltage and an input power supply voltage for generating the first power supply voltage based on a maximum grayscale of the input frame data and a load of the output frame data.

2. The display device of claim 1, wherein the driving control circuit determines the input power supply voltage to be higher than the first power supply voltage by a predetermined voltage, and the driving voltage supplying circuit generates the first power supply voltage by buck-converting the input power supply voltage.

3. The display device of claim 1, wherein the scale factor is determined based on a net power control graph indicating a correlation between the scale factor and the load of the input frame data.

4. The display device of claim 3, wherein the scale factor decreases as the load of the input frame data increases when the load of the input frame data is greater than a reference load in the net power control graph.

5. The display device of claim 1, wherein the first power supply voltage is determined based on a power supply voltage variation graph indicating a correlation among the first power supply voltage, the load of the output frame data, and the maximum grayscale of the input frame data.

6. The display device of claim 5, wherein the first power supply voltage increases as the maximum grayscale of the input frame data increases and increases as the load of the output frame data increases in the power supply voltage variation graph.

7. A display device comprising:
a display panel including pixels;
a gate driving circuit which provides a gate signal to the display panel;
a data driving circuit which provides a data signal to the display panel;
a driving voltage supplying circuit which supplies a gate driving voltage to the gate driving circuit, supplies a data driving voltage to the data driving circuit, and supplies a panel driving voltage including a first power supply voltage and a second power supply voltage lower than the first power supply voltage to the display panel; and
a driving control circuit which controls the gate driving circuit, the data driving circuit, and the driving voltage supplying circuit,
wherein the driving control circuit determines a scale factor based on a load of input frame data, generates output frame data by applying the scale factor to the input frame data, and determines the first power supply voltage and an input power supply voltage for generating the first power supply voltage based on a brightness mode of the display panel.

8. The display device of claim 7, wherein the driving control circuit determines the input power supply voltage to be higher than the first power supply voltage by a predetermined voltage, and the driving voltage supplying circuit generates the first power supply voltage by buck-converting the input power supply voltage.

9. The display device of claim 7, wherein the driving control circuit determines a first set voltage as the first power supply voltage when the brightness mode is a high-brightness mode having a first dynamic range, and determines a second set voltage lower than the first set voltage as the first power supply voltage when the brightness mode is a low-brightness mode having a second dynamic range narrower than the first dynamic range.

10. The display device of claim 9, wherein the scale factor is determined based on a first net power control graph indicating a first correlation between the scale factor and the load of the input frame data when the brightness mode is the high-brightness mode, and
wherein the scale factor is determined based on a second net power control graph indicating a second correlation between the scale factor and the load of the input frame data when the brightness mode is the low-brightness mode.

11. The display device of claim 10, wherein the scale factor decreases as the load of the input frame data increases when the load of the input frame data is greater than a reference load in the first net power control graph, and
wherein the scale factor has a predetermined fixed value regardless of the load of the input frame data in the second net power control graph.

12. The display device of claim 9, wherein the first power supply voltage is determined based on a power supply voltage variation graph indicating a correlation among the first power supply voltage, the load of the output frame data, and a luminance usage range of the brightness mode.

13. The display device of claim 12, wherein when the brightness mode is the high-brightness mode, the first set voltage corresponding to a maximum usage luminance of the high-brightness mode is determined as the first power supply voltage in the power supply voltage variation graph.

14. The display device of claim 12, wherein when the brightness mode is the low-brightness mode, the second set voltage corresponding to a maximum usage luminance of the low-brightness mode is determined as the first power supply voltage in the power supply voltage variation graph.

15. An electronic device comprising:
a processor which renders input frame data; and
a display device which displays an image corresponding to output frame data generated by applying a scale factor to the input frame data on a display panel and varies a first power supply voltage applied to the display panel and an input power supply voltage for generating the first power supply voltage based on a maximum grayscale of the input frame data and a load of the output frame data.

16. The electronic device of claim 15, wherein the display device includes:
the display panel including pixels;
a gate driving circuit which provides a gate signal to the display panel;
a data driving circuit which provides a data signal to the display panel;
a driving voltage supplying circuit which supplies a gate driving voltage to the gate driving circuit, supplies a data driving voltage to the data driving circuit, and supplies a panel driving voltage including the first power supply voltage and a second power supply voltage lower than the first power supply voltage to the display panel; and
a driving control circuit which controls the gate driving circuit, the data driving circuit, and the driving voltage supplying circuit, and
wherein the driving control circuit determines the scale factor based on a load of the input frame data, generates the output frame data by applying the scale factor to the input frame data, and determines the first power supply voltage and the input power supply voltage based on the maximum grayscale of the input frame data and the load of the output frame data.

17. The electronic device of claim 16, wherein the driving control circuit determines the input power supply voltage to be higher than the first power supply voltage by a predetermined voltage, and the driving voltage supplying circuit generates the first power supply voltage by buck-converting the input power supply voltage.

18. An electronic device comprising:
a display device of claim 7; and
a processor which renders the input frame data.

19. The electronic device of claim 18, wherein the driving control circuit determines the input power supply voltage to be higher than the first power supply voltage by a predetermined voltage, and the driving voltage supplying circuit generates the first power supply voltage by buck-converting the input power supply voltage.
